(19) United States
(12) Patent Application Publication
(10) Pub. No.: US 2004/0192262 A1
(43) Pub. Date: Sep. 30, 2004

(54) Processing method for automatically recording caller's message in cellular telephone

(75) Inventors: Vincent Wu, Taoyuan Hsien (TW); Angus Lin, Taoyuan Hsien (TW)

Correspondence Address: BACON & THOMAS, PLLC, 625 SLATERS LANE, FOURTH FLOOR, ALEXANDRIA, VA, 22314

(73) Assignee: GVC Corporation, Taoyuan Hsien (TW)

(21) Appl. No.: 10/222,896

(22) Filed: Aug. 19, 2002

(30) Foreign Application Priority Data
Jun. 27, 2002 (TW) 091114221

(51) Int. Cl. H04M 11/10; H04M 3/42

(52) U.S. Cl. 455/413; 455/417; 455/412.1; 455/414.1

(57) ABSTRACT

A processing method for automatically recording caller's message in a cellular telephone is mainly used to answer a telephone call automatically when a cellular telephone user is busy. The method chooses a proper host welcome message to answer the caller to let him understand why the user cannot answer the telephone call by himself and ask the caller to leave a message in the telephone through a situation modes established by the user. The user can record automatic answering speech beforehand in a situation mode establishment item and establish processing modes after answering the telephone automatically. Thereby, the caller can understand why a phone call is refused to answer and the user can save a telephone fee.

### TECHNICAL FIELD

The present invention relates to a processing method for automatically recording a caller's message in a cellular phone, and more particularly to a method that a cellular telephone automatically answer a phone call through an establishment of a situation mode when a user cannot answer the phone himself.

### BACKGROUND OF THE INVENTION

Although a cellular telephone can bring the convenience of personal mobile communication to a person, but not everybody prepares to answer phone calls any time. An incoming phone call should be transferred to a voice mailbox, if a user is attending a meeting, driving a car or sleeping and unable to answer the phone. At present, a message-leaving solution proposal provided by telecommunications industry requires the user to dial a particular telephone number afterwards to listen to the message left by a caller. In this way, it not only wastes money, but also has no way to inform the caller why the phone call cannot be answered.

### SUMMARY OF THE INVENTION

A processing method for automatically recording a caller's message in a cellular telephone according to the present invention is to set situation modes in a cellular telephone beforehand to answer phone calls automatically and to pick up a proper host welcome message to inform a caller to let him understand why no answer from the opposite and to leave a message in the telephone when a user is unable to answer the phone call immediately. The user can also record an automatic answering speech in a situation mode establishment items and set a processing way after automatic answering beforehand, such as recording a caller's voice automatically or answering the phone in a hand-free mode.

The main object of the present invention is to provide a processing method for automatically recording a caller's message in a cellular telephone. Through this method, a cellular telephone can answer a phone call automatically and immediately through a situation mode set by a user when the user is unable to answer the phone by himself. A proper message is chosen to inform a caller to let the caller know why the user himself cannot answer the phone call.

Another object of the present invention is to provide a processing method for automatically recording a caller's message in a cellular telephone. Through this method, a user can set an automatic answering recording voice in a cellular telephone beforehand, and ask a caller to leave his voice message in the telephone automatically. Therefore, the user can have the voice message from the cellular telephone itself, this can save telephone fee for the user.

### BRIEF DESCRIPTION OF THE DRAWINGS

Other objects, features, and advantages of the invention will become apparent from the following detailed description of the preferred but non-limiting embodiments. The description is made with reference to the accompanying drawings in which: Table 1 is a graph, showing examples of preset host welcome messages according to a preferred embodiment of the present invention;

FIG. 1 is a flow chart, showing steps for setting processing function of automatic message recording according to a preferred embodiment of the present invention; and

FIG. 2 is a flow chart, showing steps for function operation of automatic message recording according to a preferred embodiment of the present invention.

### DETAILED DESCRIPTION OF THE INVENTION

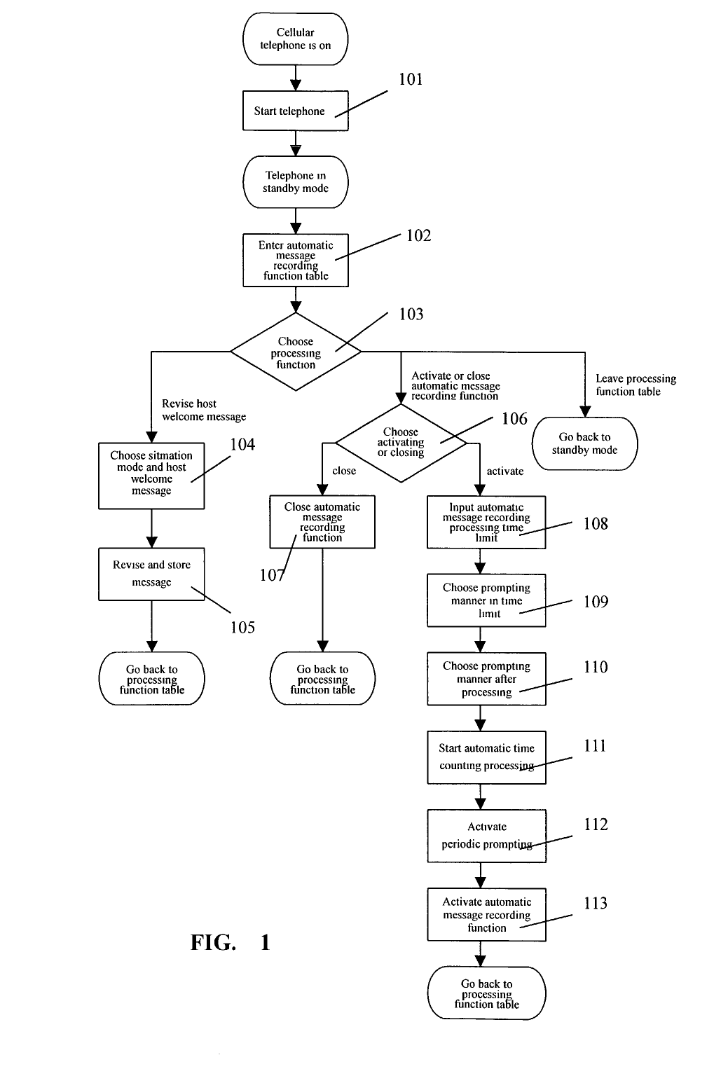

First, please refer to FIG. 1, which illustrates steps for setting a processing function of automatic message recording. In the beginning, power a cellular telephone on, and then start the cellular telephone (step 101). Enter an automatic message recording function table preset in the cellular telephone in a standby mode (step 102). Thereafter, choose a processing function (step 103). Select a “situation mode and host welcome message” item if a host welcome message needs to be changed (step 104). Revise and store the message after entering the item (step 105). Go back to the processing function table after the revision and the storing are done. And then, choose a “starting or closing the automatic message recording” item (step 106). Close the automatic message recording function if closing automatic message recording item is chosen (step 107), and then go back to the processing function table. If starting automatic message recording is chosen, input the time limit of the automatic message recording processing (step 108) first, and then choose voice or vibration as a prompting signal in the period of the automatic processing (step 109). Furthermore, choose voice or vibration as a prompt signal when the automatic processing is over (step 110). Here, the sequence of the step 109 and 110 can be changed. Next, start the time counting of the automatic processing time limit (step 111), start a periodic message prompting (step 112) and start the automatic message recording function (step 113), and then go back to the processing function table. But, go back directly to the standby mode, if leaving processing function table in choosing process function is chosen at the step 103.

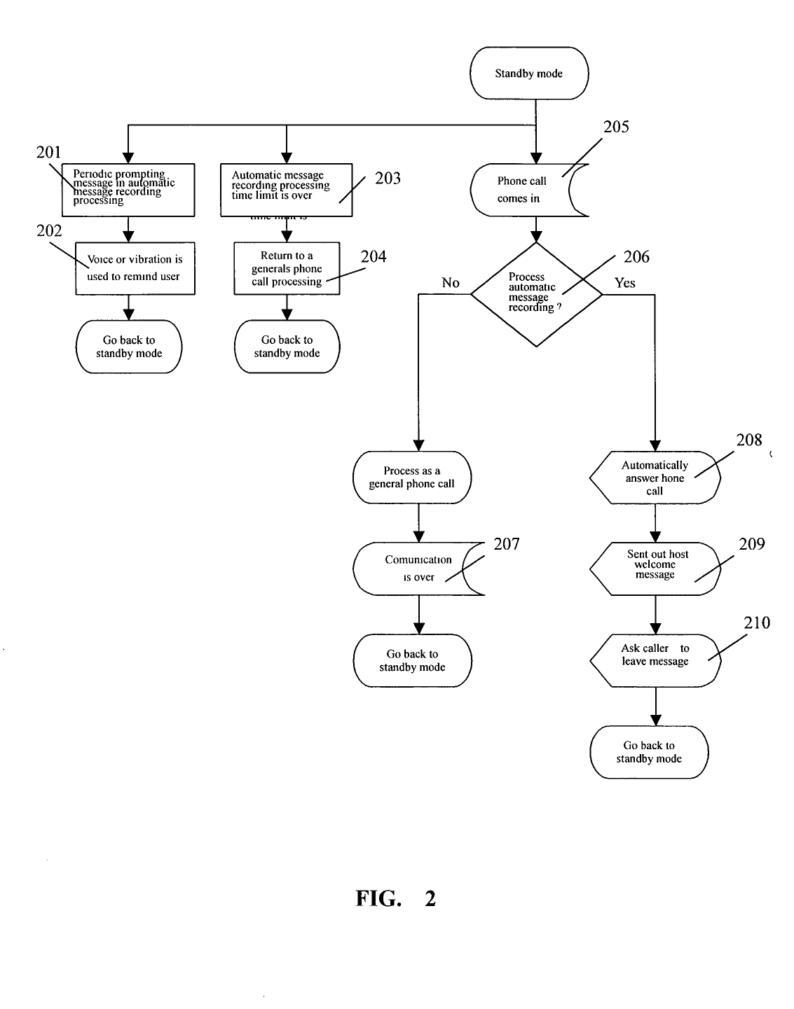

Furthermore, please refer to FIG. 2, which shows the steps for the operation of automatic message recording function. Here, emit a periodic prompt in the automatic message recording processing when the cellular telephone is in the standby mode (step 201). Prompt the user with voice or vibration from the cellular telephone (step 202), and then go back to the standby mode. If the time counting of the automatic message recording time limit is up (step 203), return to a general phone call processing way to process a phone call (step 204), then go back to the standby mode. In the standby mode, if a phone call comes in (step 205), check whether the automatic message recording processing is started (step 206). Process the phone call with the normal process for a phone call and go back to the standby mode after terminating a communication (step 207). The cellular telephone answers the phone automatically (step 208) if the automatic message recording processing is activated. And next, send the selected host welcome message (step 209), and then ask the caller to leave message (step 210). Thereafter, go back to the standby mode.

The examples of the automatic message recording are shown in Table 1. Although Table 1 illustrates only two kinds of host welcome messages, but in fact they are more in practice. The first situation is that a user sets a situation mode to be “in the course of the conference” in a cellular telephone before attending a conference. A chosen host welcome message is “I am in the course of a conference, please leave your message directly” when the user has no opportunity to answer a phone. The time limit for refusing to answer a phone call is one hour. Meanwhile, a periodic prompting is set to be a vibration and a different kind of vibration is prompted after a processing for refusing to answer the phone is done. This processing method is activated immediately when a phone call comes in during the conference. The cellular telephone answers the phone automatically, broadcasts the host welcome message to let the caller know why the user cannot answer the phone himself as well as prompts the user with the vibration.

The second situation is that a user sets a situation mode to be “in the middle of driving a car” in a cellular telephone before driving a car. The user also set the cellular telephone to answer a phone call automatically and to communicate with the caller through a speaker. The processing method according to the present invention is activated when the user is driving a car. The cellular telephone answers the phone call automatically and broadcasts “I am driving a car now, and will communicate with you in a hand-free mode° Thereafter, they can talk with each other through the speaker directly.

From the description mentioned above, the present invention has the following effects.

(1) Situation modes and host welcome messages in common use can be preset when cellular telephones leave the factory.

(2) A user can revise and store preset situation modes and host welcome messages in a cellular telephone.

(3) A user can set the time limit for automatic message recording in a cellular telephone beforehand.

(4) A cellular telephone user can set automatic message recording or direct manual telephone answering in situation modes.

(5) The processing method according to the present invention is activated immediately when a phone call comes in. The cellular telephone answers a caller with the pre-selected host welcome message and asks the caller to leave message if the automatic message recording is appointed. The cellular telephone takes a normal procedure to process the phone call if manual telephone answering is appointed.

(6) A cellular telephone reminds a user that the cellular telephone has already recorded the caller's message through a prompting manner such as voice or vibration after the automatic message recording is processed.

(7) A user can set a periodic prompting manner such as voice or vibration in the time limit of the automatic phone call refusal processing to remind the user that the automatic message recording has been set in the cellular telephone. The user can choose removing automatic message recording from the items of the situation mode function table in the cellular telephone anytime and change the automatic message recording to a manual processing.

TABLE 1

| No. | Host Welcome Message |
|---|---|
| 1 | I am in the course of a conference, please leave your message |
| | directly. |
| 2 | I am driving a car now, and will communicate with you in a |
| | hand-free mode. |

What is claimed is:

1. A processing method for automatically recording a callers message in a cellular telephone, mainly comprising the steps as follows:
(a) setting situation modes and host welcome messages in a cellular telephone;
(b) said cellular telephone automatically answering a phone call when a user has on opportunity to answer the phone; and
(c) choosing a proper host welcome message to answer said phone call why said user cannot answer said phone call by himself.

2. The method of claim 1, wherein said user can set an automatic message recording or direct manual telephone answering in said situation modes beforehand.

3. The method of claim 2, wherein the following step can be processed after said (c) step:
(d) a caller who makes a phone call can leave message in said cellular telephone if said user chooses said automatic message recording set in said situation modes.

4. The method of claim 1 or 3, wherein said situation modes and said host welcome message can be preset in said cellular telephone when said cellular telephone leaves the factory.

5. The method of claim 1 or 3, wherein said user can revise and store said situation modes and said host welcome message.

6. The method of claim 2, wherein said user can set a time limit for said automatic message recording beforehand.

7. The method of claim of claim 3, wherein a prompting manner is used to remind said user that said cellular telephone has already recorded a caller's message automatically after said (d) step.

8. The method of claim 7, wherein said prompting manner can be voice or vibration.

9. The method of claim 6, wherein said user can set a periodic prompting manner to remind said user that said automatic message recording has already set in said cellular telephone.

10. The method of claim, wherein said periodic prompting manner can be voice or vibration.

11. The method of claim 2, wherein said cellular telephone processes said phone call with a normal procedure if said user choose said direct manual telephone answering set in said situation modes.
